(19) United States
(12) Patent Application Publication
(10) Pub. No.: US 2009/0078286 A1
(43) Pub. Date: Mar. 26, 2009

(54) METHODS FOR PROTECTING FLOORING DURING A FLUID BASED CLEANING AND DEVICES THEREOF

(76) Inventor: Geno Cervini, Rochester, NY (US)

Correspondence Address: NIXON PEABODY LLP - PATENT GROUP, 1100 CLINTON SQUARE, ROCHESTER, NY, 14604, US

(21) Appl. No.: 12/204,303

(22) Filed: Sep. 4, 2008

Related U.S. Application Data
(60) Provisional application No. 60/969,822, filed on Sep. 4, 2007.

(51) Int. Cl. B08B 13/00

(52) U.S. Cl. 134/18; 428/41.7; 428/43

(57) ABSTRACT

A method and device for protecting flooring during a cleaning includes identifying at least one contact point between flooring and at least one object resting on the flooring. At least a portion of one surface of a protection pad which has a re-adherable adhesive is applied to a portion of the object which is at the identified contact point when resting on the flooring. At least one cleaning operation on the flooring which involves fluid and movement of the object to one or more locations on the flooring is performed. The protection pad remains secured to the portion of the object during the movement of the object to protect the flooring. The protection pad is removed from the portion of the object once the fluid applied during the cleaning operation has substantially dried.

This application claims the benefit of U.S. Provisional Patent Application Ser. No. 60/969,822 filed Sep. 4, 2007, which is hereby incorporated by reference in its entirety.

### FIELD OF THE INVENTION

The present invention generally relates to cleaning methods and, more particularly, to methods for protecting flooring during a fluid based cleaning and devices thereof.

### BACKGROUND

Commercial carpet cleaning operations typically involve a number of steps. By way of example, in one commercial cleaning operation the carpet to be cleaned is cleared of debris and vacuumed. Next, any stains and spots in the carpet are pretreated. Once the stains and other spots are pretreated, a pressure sprayer with a carpet cleaning solution is applied to the carpet and then the solution is extracted from the carpet.

During these cleaning steps, furniture and other objects on the carpet are moved so all areas of the carpet can be cleaned. To prevent any bleeding or other damage from the placement of the furniture on any areas of wet carpet during this movement, typically a loose sheet or pad is placed under the legs of each piece of furniture or object each time it is moved. Once the carpet has dried, the loose sheets are removed and discarded.

Accordingly, with this commercial cleaning procedure the entire surface of the carpet can be effectively cleaned. Unfortunately, a substantial amount of time and energy can be spent every time furniture or other objects need to be moved and then loose sheets or pads are placed under each leg. Additionally, when furniture or other objects needs to be moved close to a wall, it can be very difficult get the loose sheets under the legs of the furniture or object located near the wall.

### SUMMARY

A method for protecting flooring during a cleaning in accordance with embodiments of the present invention includes identifying at least one contact point between flooring and at least one object resting on the flooring. At least a portion of one surface of a protection pad which has a re-adherable adhesive is applied to a portion of the object which is at the identified contact point when resting on the flooring. At least one cleaning operation on the flooring which involves fluid and movement of the object to one or more locations on the flooring is performed. The protection pad remains secured to the portion of the object during the movement of the object to protect the flooring. The protection pad is typically removed from the portion of the object once the fluid applied during the cleaning operation has substantially dried.

A protection pad for protecting flooring during a cleaning in accordance with embodiments of the present invention includes at least one layer which is substantially fluid proof and chemically resistant and a re-adherable adhesive on at least a portion of a surface of the at least one layer. The layer may also include a substantially rigid portion and a substantially flexible portion which extends around at least a portion of substantially rigid portion. Additionally, scores may extend in from an outer perimeter of the substantially flexible portion towards the substantially rigid portion to facilitate attachment to the legs of the furniture and provide greater protection to the flooring.

The present invention provides a number of advantages including providing a faster and more effective method for cleaning and protecting carpets and other types of flooring. With the present invention, the carpet cleaning protection pads can quickly and easily be installed on legs of furniture and other contact points of objects with the carpet or other type of flooring. Once installed, the furniture or objects can be easily moved around the room and against the wall during clean operations without the need to repeatedly lift and reposition the protection pads. When the carpet or other type of flooring is dry, the protection pads can easily be detached from the bottom of the legs of the furniture and discarded. Accordingly, for commercial cleaners the use of these protection pads substantially increases the speed in which carpets or other type of flooring can cleaned enabling more carpets to be cleaned and more revenue to be generated.

### BRIEF DESCRIPTION OF THE DRAWINGS

FIG. 1 is a perspective view of a roll of carpet cleaning protection pads in accordance with embodiments of the present invention;

FIG. 2 is a top view of a carpet cleaning protection pad in accordance with embodiments of the present invention; and

FIG. 3 is a flow chart of a method for protecting flooring during a fluid based cleaning in accordance with embodiments of the present invention.

### DETAILED DESCRIPTION

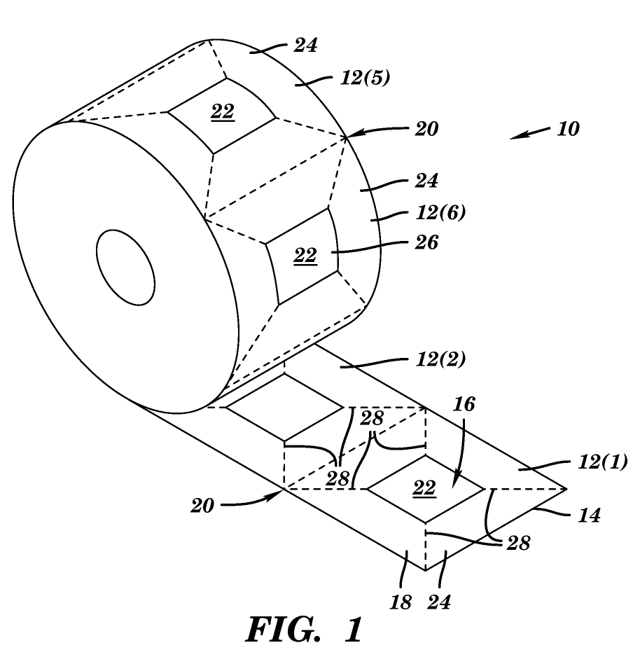

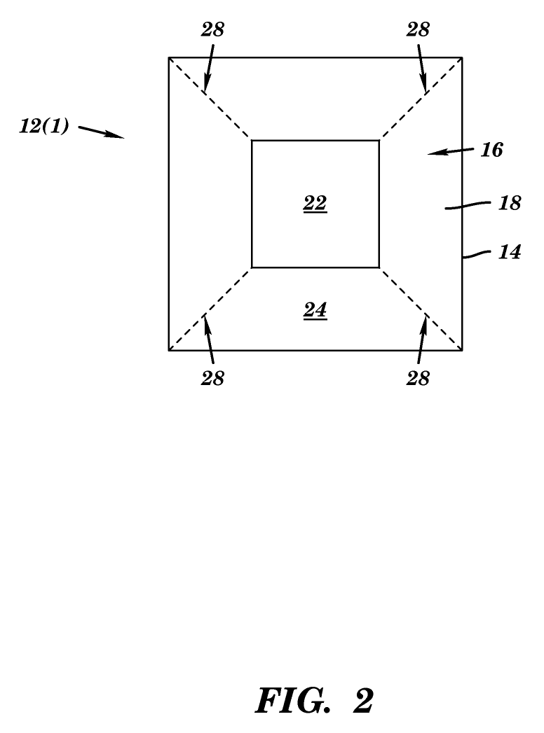

A roll 10 of carpet cleaning protection pads 12(1)-12(n) in accordance with embodiments of the present invention is illustrated in FIGS. 1 and 2. Each of the carpet cleaning protection pads 12(1)-12(n) include a substantially fluid proof and chemically resistant layer 14 with a re-adherable adhesive 16 on one surface 18 of the fluid proof layer 14, although the pad could have other types and numbers of elements connected in other manners. The present invention provides a number of advantages including providing a faster and more effective method for cleaning and protecting carpets and other types of flooring.

Referring to FIG. 1, the roll 10 comprises a sequential series of protections pads 12(1)-12(n) on the roll 10, although the protection pads can be provided in other formats, such as a continuous tape that an operator can unroll and cut to the desired length or as separate pads. In this particular example, adjoining protection pads 12(1)-12(n) are each detachably connected together along a detachment perforation 20, although other manners for detachably connecting the perforation pads 12(1)-12(n) can be used. The roll 10 can be loaded onto a dispenser (not shown), although the protection pads 12(1)-12(n) can be supplied in other types of devices and in other manners, such as in a pad format by way of example only.

Referring to FIGS. 1 and 2, each of the protection pads 12(1)-12(n) has a substantially fluid proof and chemically resistant layer 14, although each of the protection pads 12(1)-12(n) can comprise other numbers and types of layers. In these embodiments, chemically resistant means the ability of the layer to resist damage by chemical reactivity or solvent action, such as from any commercial cleaning products by way of example only. A re-adherable adhesive 16 is located on one surface 18 of each of the protection pads 12(1)-12(n) and is used to detachably secure each of the protection pads 12(1)-12(n) to the contact points of the object with the flooring while stationary or during movement for cleaning operations, although other numbers and types of adherents can be used. A surface of the layer 14 opposing the surface 18 is substantially smooth to assist the object or objects on which the protection pads 12(1)-12(n) are attached to slide along the flooring, although this surface may have other textures.

In this particular example, each of the protection pads 12(1)-12(n) also includes a substantially rigid portion 22 which is surround by a substantially flexible outer perimeter portion 24, although each of the protection pads 12(1)-12(n) can comprise other numbers and types of portions, such as just a single flexible portion for the entire portion of layer 14. As illustrated with protection pad 12(5), the substantially rigid portion 22 can comprise another substantially fluid proof and chemically resistant layer 26 which is secured to the layer 14 which comprises the substantially flexible portion 24, although other numbers and types of layers can be used.

In this particular example, each of the protection pads 12(1)-12(n) also includes scores 28 which extend in from the corners of the outer perimeter of the substantially flexible portion 24 of each of the protection pads 12(1)-12(n) to the substantially rigid portion 22 of each of the protection pads 12(1)-12(n), although other numbers and types of scores, in other locations and orientations, and the absence of any scores could be used. The scores 28 can be used to assist with the folding of each of the protection pads 12(1)-12(n) around the contact points of the object with the flooring, although the scores can be used in other manners, such as to assist with tearing the scores 28 open or otherwise apart to assist with the folding of each of the protection pads 12(1)-12(n) around the contact points.

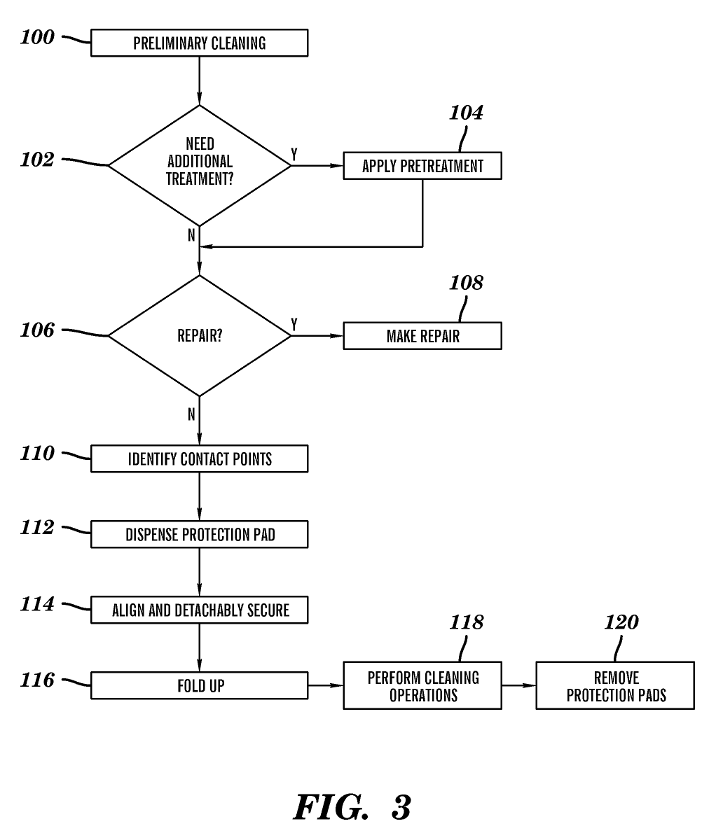

A method for protecting flooring during a fluid based cleaning in accordance with embodiments of the present invention will now be described with reference to FIGS. 1-3. In step 100, the flooring to be cleaned is initially swept and/or vacuumed to remove as much dirt and other debris as possible, although other numbers and types of initial cleaning operations could be performed. In this particular example, the flooring is a carpet, although other types and numbers of floorings could be used, such as wood flooring, laminate flooring, raised flooring, and linoleum.

In step 102, a determination is made on whether there are any regions in the area of flooring to be cleaned which are soiled, stained or otherwise need additional treatment are identified. If there are no regions in the area to be cleaned which are soiled, stained or otherwise need additional treatment, then the No branch is taken to step 106. If there are one or more regions in the area to be cleaned which are soiled, stained or otherwise need additional treatment, then the Yes branch is taken to step 104. In step 104, one or more pretreatment cleaning solutions are applied to the one or more identified regions in the area to be cleaned identified depending on the particular problem, although other manners for cleaning the one or more identified regions can be used.

In step 106, a determination is made on whether there are one or more regions in the area which need to be repaired. If there are no regions in the area which need to be repaired, then the No branch is taken to step 110. If there are one or more regions in the area to be repaired, then the Yes branch is taken to step 108. In step 108, the one or more regions in the area which need to be repaired are either repaired or replaced, although other types of corrective actions in these areas could be conducted.

In step 110, the contact points between each object, such as legs of furniture, and the area of flooring to be cleaned are identified. Next, each of the objects is raised to provide a space between the portion of the object at the contact point and the area to be cleaned.

In step 112, one of the protection pads 12(1)-12(n) is dispensed from a sequential roll of the protection pads 12(1)-12(n) by tearing along the perforation 20, although other manners for obtaining one of the protection pads 12(1)-12(n) can be used. Additionally, one or more of the protection pads 12(1)-129n) can be dispensed and applied at other times, such as before any cleaning operations or after all cleaning operations by way of example only. If the protection pads 12(1)-12(n) initially comprise a continuous sheet on the roll 10, then the cleaning operator can cut the appropriate length of the sheet for the protection pad. The cleaning operator may have multiple dispensing rolls of protection pads 12(1)-12(n) of different sizes to select from depending on the size of the contact point to be covered.

In step 114, the surface 18 with the adhesive 16 for the one of the protection pads 12(1)-12(n) which was dispensed is aligned with and is detachably secured to one of the contact points of the object. More specifically, in this particular example the substantially rigid portion 22 with the adhesive 16 for the one of the protection pads 12(1)-12(n) is aligned with and is detachably secured to one of the contact points of the object, although the one of the protection pads 12(1)-12(n) could be aligned and detachably secured in other manners. As described earlier, an opposing surface of the substantially rigid portion 22 from the surface 18 provides a substantially smooth and rigid surface on which the object can be more easily slid along the flooring, although the surface could have other configurations and textures.

In step 116, the substantially flexible portion 24 for the one of the protection pads 12(1)-12(n) and which also has the adhesive 16 can be folded back up on and detachably secured to a portion of the object adjacent to the contact point and which is not parallel with the flooring to provide further protection to the flooring. Additionally, the scores 28 can be partially torn open or apart to further facilitate folding the substantially flexible portion 24 back up on and detachably secured to a portion of the object adjacent to the contact point.

In step 118, once one of the protection pads 12(1)-12(n) is secured to each of the contact points of the objects in the area to be cleaned, then one or more cleaning operations can be performed on the flooring, such as steam cleaning, rinsing, and extracting, although other types and numbers of cleaning operations could be performed. With one of the protection pads 12(1)-12(n) is secured to each of the contact points of the objects in the area to be cleaned, the flooring is protected from discoloration or other staining from the object resulting from exposure to any fluid based cleaning operation on the flooring. Additionally, once one of the protection pads 12(1)-12(n) is secured to each of the contact points of the objects in the area to be cleaned, the objects can be moved with ease around the area to be cleaned, without the need to move, readjust, or reapply any of the protection pads 12(1)-12(n) which are being used.

In step 120, once the flooring is sufficiently dry, the protection pads 12(1)-12(n) which have been detachably installed, can be easily removed and discarded, although the pads 12(1)-12(n) which have been detachably installed can be removed at other time based on other factors. Typically, the flooring needs to dry overnight before removal of the protection pads 12(1)-12(n) which have been detachably installed, although other time periods could be required depending on the particular cleaning operations.

Accordingly, as illustrated and described above, the present invention provides a number of advantages including providing a faster and more effective method for cleaning and protecting carpets and other types of flooring. With the re-adherable adhesive, the protection pads 12(1)-12(n) are each able to remain with the object as it is moved around the flooring during the cleaning operation or operations. This saves the operator a substantial amount of time during the cleaning procedure because the operator does not need to continually place protection under the object each time it is moved. Additionally, when the contact point on the portion of the object is adjacent the wall, the protection pads 12(1)-12(n) can simply be detachably secured to the object when it is pulled away from the wall and then slid back against the wall, without the need for the cleaning operator to try to lift and apply protection at the contact point once the object is resting adjacent the wall.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefor, is not intended to limit the claimed processes to any order except as may be specified in the claims. Accordingly, the invention is limited only by the following claims and equivalents thereto.

What is claimed is:

1. A method for protecting flooring during a cleaning, the method comprising:
identifying at least one contact point between flooring and at least one object resting on the flooring;
applying at least a portion of one surface of a protection pad which has a re-adherable adhesive to a portion of the object which is at the identified contact point when resting on the flooring;
performing at least one cleaning operation on the flooring which involves fluid and movement of the object to one or more locations on the flooring, the protection pad remaining secured to the portion of the object during the movement of the object to protect the flooring; and
removing the protection pad from the portion of the object.

2. The method as set forth in claim 1 further comprising dispensing the protection pad from a continuous roll of the protection pad.

3. The method as set forth in claim 2 wherein the dispensing further comprises tearing along a detachment perforation between two of the protection pads.

4. The method as set forth in claim 1 further comprising raising the object at the identified contact point to provide a space for the applying.

5. The method as set forth in claim 1 further comprising returning the object to an original location after the performing, the protection pad remaining secured to the portion of the object until the removing.

6. The method as set forth in claim 1 wherein the at least one cleaning operation on the flooring comprises at least one of steam cleaning, rinsing, and extracting.

7. The method as set forth in claim 1 wherein an outer perimeter of the protection pad is larger than the outer perimeter of the portion of the object.

8. The method as set forth in claim 7 wherein the applying further comprises folding at least one side of the protection pad back on to a part of the portion of the object which is not parallel with the flooring.

9. The method as set forth in claim 8 wherein the applying further comprises folding all sides of the protection pad back on to a part of the portion of the object which is not parallel with the flooring.

10. The method as set forth in claim 1 wherein the applying further comprises positioning a substantially rigid portion of the protection pad which is separated from an outer perimeter of the protection pad by a substantially flexible portion on the identified contact point.

11. The method as set forth in claim 10 wherein the at least one layer is substantially fluid proof.

12. The method as set forth in claim 10 wherein the applying further comprises at least partially tearing open a score which extends in from an outer perimeter of the protection pad towards the substantially rigid portion.

13. A protection pad for protecting flooring during a cleaning, the pad comprising:
at least one layer which is substantially fluid proof and is chemically resistant; and
are-adherable adhesive on at least a portion of a surface of the at least one layer.

14. The pad as set forth in claim 13 wherein the at least one layer further comprises:
a substantially rigid portion; and
a substantially flexible portion which extends around at least a portion of substantially rigid portion.

15. The pad as set forth in claim 14 wherein the at least one layer comprises two or more of the layers, one of the layers comprises the substantially rigid central portion of the protection pad which is attached to another one of the layers which comprises the substantially flexible portion.

16. The pad as set forth in claim 15 wherein the two or more layers are substantially fluid proof.

17. The pad as set forth in claim 14 further comprising at least one score which extends along from an outer perimeter of the one of the layers which comprises the substantially flexible portion to the one of the layers which comprises the substantially rigid central portion.

18. The pad as set forth in claim 13 further comprising at least one score which extends in from an outer perimeter of the at least one layer.

19. The pad as set forth in claim 13 further comprising a sequential roll of the at least one layer, wherein each of the adjacent layers are separated by a detachment perforation.
